(19) United States
(12) Patent Application Publication
(10) Pub. No.: US 2013/0055933 A1
(43) Pub. Date: Mar. 7, 2013

(54) Removable and portable security container system

(71) Applicants: Mikhail S. Markman, Mableton, GA (US); Kim Sherman, Acworth, GA (US)

(72) Inventors: Mikhail S. Markman, Mableton, GA (US); Kim Sherman, Acworth, GA (US)

(21) Appl. No.: 13/199,676

(22) Filed: Sep. 7, 2011

(51) Int. Cl. E05G 1/04; B23P 11/00; E05G 1/026

(52) U.S. Cl. 109/50; 29/525.01

(57) ABSTRACT

A portable and removable security container assembly and a method of its use are described. The assembly includes a docking bracket that is secured permanently to a substrate surface in either a motor vehicle or a building, and a lock-box or safe. The safe has a housing that has at least two cavities or compartments, in one of which is situated a locking mechanism of a latching assembly. The safe is adopted to engage with the docking bracket and fastened in place by means of the locking mechanism. The control for the latching assembly is accessible and activated only from within the safe. When the safe is placed in the docking bracket, the locking mechanism is aligned with engagement elements of the docking bracket. The latch assembly includes a rotatable carousel centered on a hub that a user can turned by a switch handle. Engagement rods or shafts are attached at a first end to the rotatable carousel and a second free end that is positioned to align and secure the free end of the engagement rod in the corresponding engagement element of the docking bracket. When unlocked from the docking bracket, the safe is removable from the docking bracket and can be portable.

### FIELD OF INVENTION

The present invention relates generally to a security container. More particularly, the invention pertains to a removable lock box or safe that can be secured to a substrate, and which can be removable and portable for a user to take and carry conveniently with them when an engaging mechanism is unlocked from inside of the lock box.

### BACKGROUND

Traditionally, people who have valuables or other things that they may seek to safeguard have looked to keep those things in safes and lock boxes which are generally designed to be immobile. Usually, a safe or lock box is rendered immobile because it is designed to be either too large or bulk and heavy to be moved easily or the safe is fixed physically to a location by bolting or welding the safe in place. As society becomes increasingly more mobile, however, consumers have shown a desire to take their valuables with them as they move about, but wish to still be able to protect their valuables when on the go.

As people in society have become increasingly tied to our motor vehicles, differentiating one's use of the vehicle between personal and business becomes more difficult. Each year people use millions of vehicles (either personal or rental) for working, living, or playing. When using a motor vehicle, it may be necessary at times to store valuables, since an item of value in the vehicle, such as computers, important papers, portable navigation devices, DVD players, game stations, digital cameras/camcorders, guns, or other valuables etc., are often found inside these vehicles. Everyday objects (e.g., wallets, cell phones, personal data assistants (PDAs), IPods, etc.) are also key targets for larceny. Although such items of value may be stored in enclosed areas of the vehicle, such as the trunk, glove compartment, or a pocket or bin, or the like, where the items are out of plain view, these places are still susceptible to forced entry. To a determined robber, these kinds of storage areas are no hindrance. And, although alarm systems are available to provide notification, such systems do not offer sufficient protection from forced entry, such as by smashing a window or prying open a lock and grabbing the valuable item. Hence, to protect against theft and safety of personal possessions, consumers often inconvenience themselves by taking the objects into stores, gyms, restaurants, etc. Fear of personal property loss ranks is a major concern among vehicle owners.

Furthermore there are costs associated with property loss due to inadequate protection. For example, in today's growing “virtual office” environment, laptop computer theft from motor vehicles is a critical concern, which can result in significant direct costs for replacement of the computer and insurance premium increases, and immeasurable indirect costs due to loss of valuable data, lost productivity, and risk to confidential business or personal information. In another example, vacationing families on road trips are the target of half of all larceny thefts from motor vehicles. These thefts can result in direct replacement costs typically in excess of $2000-$3000, increased post-claim insurance premiums, and most importantly a greatly diminished sense of personal security.

Conventional safes or lock boxes can provide additional protection for storing valuable items in that a safe is more difficult to open than ordinary containers, but they are not easily transported or installable in vehicles. Over the years, several devices have been developed that enable a user to install a security container on a mountable surface. A recurring feature in such devices has focused on differences in way such containers are installed. Most have involved an external apparatus to fasten the container to its mount. This kind of approach, while convenient for one to position the security container and fasten down, does not prevent or hinder a determined robber from removing the container. This is precisely because the operational mechanisms of the locking assembly are situated outside of the housing of the security container, where anyone can access it. Hence, there is an unsatisfied need for a secure yet portable security container that is lockable, structurally sound and easily removable by the intended user. This device improves over previous designs and it has the ability to secure goods.

Ideally, one would hope to have the advantage of a security container that can embody what may sound to be opposing qualities of being both relative secure immobility and convenient portability to be able to take the lock box with one when on the go. To be both effective and practical for on-the-go lifestyles, however, a security container requires the flexibility to be portable and easily removable by the owner or user, and provide structural integrity in its associated locking mechanism.

### SUMMARY OF THE INVENTION

The present invention relates to a security assembly or system that is both portable as well as easily securable to components that are fastened or mounted permanently to a substrate located either in a building structure or on board a motor vehicle, such as an automobile, airplane, or boat. Overall, it is expected that the apparatus can be installed in buildings as well as motor vehicles while advantageously providing portability to the user.

In general, the security assembly includes a docking bracket and a removable and portable security container. The docking bracket has at least a first flange and a second flange. The first and second flanges are oriented relative to each other at a substantially orthogonal angle (e.g., 90°±3°. The second flange extends from an edge of the first flange and provides a guide or backstop for placing the security container and additional features of the security assembly. The first flange serves as the base of the bracket and has a number of holes through which fastening elements, such as bolts or screws 101 with nuts 103 and washers 105 can be inserted to secure the docking bracket to the mountable substrate surface, such as depicted in FIG. 15. Also, the first flange has at least one engaging member for engaging a latch assembly. The engagement tab or member extends from the plane of the first flange at an angle. In certain embodiments the engagement tab can be oriented to protrude at an angle of between about 30° or 40° up to about substantially perpendicular to the plane of the first flange, or bent partially in a combination thereof. The first flange can be attached permanently to the mountable substrate, providing a secure anchor for the security container to dock with. In addition to the first and second flange, the docking bracket can also have a third flange and a fourth flange, situated at the ends of the first and second flanges such that the third and fourth flanges oppose each other. A docking bracket with the third and fourth flanges exhibits greater torsional rigidity than one that does not.

The assembly also includes a security container, such as a safe or lock box, having a housing as defined by least a side wall, a bottom wall, and a top wall or cover, all defining an interior space. Within the housing, the security container has at least a first compartment and a second compartment. A rigid barrier wall separates the first compartment from the second compartment. The first compartment is typically the larger of the two, and is configured to be a main storage space for valuables or other items. The first compartment space is accessible from the outside through a large exterior opening which has a lockable door or cover, located in either the top wall or a side wall of the security container. The locking mechanism of the exterior door can be of any practicable variety. The second compartment contains an actuating mechanism for a latching assembly having a number of engagement rods or lateral bolts that are linked to a rotating or flexing member. The rotating or flexing member is connected to a switch handle or activator situated in or on the rigid barrier that separates the first and second compartments. Except for the handle of the switch, all of the other latching assembly components are hidden from view of the first compartment. Of the latching assembly components, only the switch handle extends through the barrier wall from the second compartment into the first compartment. In order to conserve space and prevent damaging items stored in the first compartment, this switch can be foldable or collapsible and stored into a recess formed in the barrier wall. This feature protects both the switch and container contents by displacing the switch out of the way of anything that may be stored in the first compartment.

The second compartment has a number of holes in an exterior wall. The security container is adapted to engage with the docking bracket, such that the engaging members of the first bracket are able to be inserted into the holes in the exterior wall of the second compartment, and the engagement rods of the latching assembly can interact with the engaging members after activation of the actuating mechanism to lock the security container in place.

According to an embodiment, the first compartment and second compartment both are configured to be on the same side of the bottom wall, and within the interior space of the security container as defined by the bottom wall, side wall, and top wall. In this embodiment, the second compartment is appropriated and configured from a division of the interior space of the security container in which the rigid barrier wall extends from the bottom wall to a side wall within the confines of the security container. Alternatively, the first and second compartments are configured to be on opposite sides of the bottom wall, with the second compartment being positioned underneath the confines of the first compartment. The bottom wall of the security container becomes the barrier wall between the first and second compartments. In this second embodiment, the first compartment encompasses the entire interior space as defined by the bottom, side, and top walls. A separate wall encloses the second compartment from underneath.

The security assembly exhibits both security and portable as the user may desire. The components include a docking bracket that is permanently secured to a substrate and a removable security container that engages with the bracket. Once the security container is engaged with the docking bracket, the security container cannot be removed from the bracket without accessing the interior of the security container. The system is configured such that a user who can open and access the interior of the security container is the only person who can release the security container from the permanently mounted docking bracket. Since one cannot access physically the latching assembly and engaging rods from outside of the security container once the container is docked and secured in the bracket, any attempt to remove the container from the bracket by means of other means or approaches will be very difficult if not impossible because of the way the latching mechanism is protected, and such an attempt may result in damage to either the mounting surface. The security container itself can be constructed with various dimensions adapted to hold and secure valuables or other items which a user would like to safeguard. The components of the invention can be secured in a variety of different environments. According to an embodiment, the actuator switch can flex or rotate a pin to activate a latch system that engages with the first flange of the bracket, further securing the container to the bracket.

In another embodiment, the actuating mechanism may also include springs that help to keep the latch system closed when the actuator is flexed or rotated to engage the engagement elements of the docking bracket. One or more springs can be attached to the actuating mechanism and the security container. The springs can be aligned to make the security container easier to engage with the bracket once the actuator is flexed or rotated. There is also another embodiment that may use a plurality of springs aligned in various states of compression and tension to optimize the user's ease of operation.

In another aspect, the present invention also describes a method of securing a lockbox or other security container. The method involves providing a bracket that is mountable to a surface, and providing a security container having a first compartment and a second compartment. The first compartment constitutes an interior volume of said lockbox separate from the second compartment. The second compartment contains a latching assembly that is adapted to interact with a complementary engaging feature of the docking bracket. Position and place the lockbox in an orientation that is substantially normal relative to the complementary engagement elements of the docking bracket, such that a number of the complementary engagement elements can insert into a number of holes in a portion of a bottom wall of the lockbox. Access the first compartment of the lockbox and turn a latch handle therein to actuate the latching assembly, such that the latching assembly aligns and engages with the complementary engagement elements.

Other features and advantages of the present invention will become evident from the following detailed description and accompanying figures. It is understood that the foregoing general description and the following detailed description and examples are merely representative of the invention, and are intended to provide an overview for understanding the invention as claimed.

### BRIEF DESCRIPTION OF THE FIGURES

FIG. 1 is a perspective view of a general illustration of the security assembly, showing two major components: a docking bracket and a security container, such as a lock box or safe. The components are positioned so as to be able to engage with each other. The interior and lock mechanism of a latching assembly are shown in a partial cut-away view of the lock box.

FIG. 2 depicts an embodiment of the docking bracket as shown in FIG. 1.

FIG. 3 depicts an alternative embodiment of the docking bracket, with a raise lip along an edge of a base flange.

FIG. 4 depicts another embodiment of the docking bracket with two sets of protruding engagement tabs from both a base flange and a back flange of the bracket.

FIG. 5 is a straight-on view illustration of the docking bracket shown in FIG. 4.

FIG. 6 is an interior view of the main or first compartment of the security container as it is set into the docking bracket.

FIG. 7 shows the door of the security container open and an interior view of the security container with a partial cutaway view of the second compartment in which the lock mechanism of a latching assembly is located according to an embodiment of the present invention.

FIG. 8 is a partial cutaway view of the security container from a side showing the latching assembly situated within the second compartment that is within but segregated from the volume of the main or first compartment.

FIG. 9 is a partial cutaway view of the security container from a side showing an alternate embodiment of the second compartment as in FIG. 8.

FIG. 10 is a partial cutaway view of the security container from a side, showing an alternative embodiment having the latching assembly situated within a second compartment located under a floor of the first compartment and within the confines of a bottom wall of the security container.

FIG. 11 is a partial cutaway view of the security container from a side, showing an alternative embodiment having the latching assembly situated within a second compartment that is placed or suspended below the bottom wall of the security container, such that the compartment is attached to the underside of the bottom wall and supported from above.

FIG. 12A is a three-quarter view from below of the bottom wall of the security container with the second compartment positioned as described in FIG. 11. According to an embodiment that is compatible with the docking bracket having the engagement tab configuration shown in FIGS. 4 and 5.

FIG. 12B is a three-quarter view from below of the bottom wall of the security container according to an alternate embodiment.

FIGS. 13A and 13B are views from above that illustrate the latching assembly engaging with the protruding tabs of the docking bracket. FIG. 13A depicts the latch in an unlocked position, and

FIG. 13B shows the same latch in a locked position. A guide or channel helps the extensions of the latch on either side of the rotary pivot or hub to align and slide easily into the opening on the protruding engagement tabs.

FIGS. 14A and 14B show a schematic of the latching assembly having one or more springs to help maintain the latch in a locked position when engaged with the protruding tabs. FIG. 14A depicts the latch in an unlocked position, and FIG. 14B shows the same latch in a locked position.

FIG. 15 is lateral cross-sectional view of the docking bracket illustrating, according to an embodiment shown in FIGS. 1 and 2, the use of a bolt, washer, and nut assembly to mount the bracket to a substrate frame.

FIG. 16 is a detailed view of the bolt, washer, and nut assembly, with the bolt shown in two different configurations: 1) conventional bolt and 2) with a frangible T-tab.

FIG. 17 shows according to a use of the present invention a security container sitting and locked within the docking bracket that is mounted within the trunk area of a motor vehicle.

### DETAILED DESCRIPTION OF THE INVENTION

In contrast to traditional safes or lock boxes that are difficult to move because they are either very large, bulky and/or very heavy, the present invention provides a consumer with a security container that can be both rendered securely immobile while allowing for convenient portability when the user desires to carry the container with him or her. The present invention builds upon and expands the concept described initially in International Application No.: PCT/US2008/80320, by Kim Sherman et al. (WO/2009/052388), which discusses a safe that has a spring-actuated locking mechanism, the contents of which are incorporated herein by reference in their entirety.

Although the present invention and the one described in '320 international application both serve a primary purpose of securing goods, and make use of a docking bracket and a security container, the similarities end there. The invention described in the'320 international application employs a design that requires an operator to activate multiple spring loaded latches, which involves several steps. A user must manually disengage each latch separately by moving a knob which controls the latch along a grooved channel. In order to properly engage or disengage, the latch springs are needed to maintaining the respective position. The configuration of latch springs on this design increases the likelihood of malfunction.

Whereas the '320 international application involved a rather complex locking system that could be subject to malfunction or breakage, in contrast, the present invention has a unitary design that employs minimal amount of moving parts. The present invention is distinguishable from the prior because according to certain embodiments, the latching mechanism uses a mechanical linkage system instead of a spring-loaded latch. Thus, the linkage system of the current invention requires only that an operator simply turn a handle that is connected to a rotating stalk to engage or disengage the lock that immobilizes the security container to the affixed bracket. Hence, the unitary design of the present invention minimalizes the number of moving parts. Moreover, these features of the present invention can maximize a user's efficiency in operation and portability. A more efficient latching system in the present invention decreases the amount of transition time of the present inventive assembly from being a portable device to being a secured container.

Hence, the present invention is a simple and elegant system for a consumer to secure one's belongings in a lock box, while also affording only the user the convenience of being able to remove the box from a motor vehicle or building when the user desires to take the lock box with him or her. The invention comprises a component system that can be fastened to a motor vehicle or building structure. A unique feature of the present invention is an ability to easily unlock the security box and detach it from a bracket that is permanently mounted to part of the motor vehicle or building. This feature affords consumers a convenience and simplicity of being able to take the portable security box or safe, like a suit case, from their vehicle with them into a building once they arrive at any desired place. This portability feature is made possible by means of securing the safe to a bracket that is permanently installed inside the vehicle, such as in a car trunk or a rear section of a sport utility vehicle (SUV). This bracket allows the safe to be latched or unlatched by means of a locking mechanism located inside the safe. This locking mechanism can be operated only from inside the safe to disengage the latch from its locked position. This portable security or lock box has a sturdy construction and unique design that will enable one to store valuable items such as laptops, important documents, even personal weapons in a part of a vehicle such as the trunk or other storage area while one is in transit or visiting restaurants, theatres, or conducting business away from the vehicle.

The apparatus combines a container that affixes to a docking bracket; once the apparatus is combined the system is fixed and immovable. These efforts, however, have been found to be unsatisfactory, especially for desired portability. Advantageously, a combined system of a security container and docking bracket works in tandem to increase the portability of the security container. The present security assembly differs from previous concepts in that the docking bracket does not need to surround or encompass the entire security container. The docking bracket that is attached to the mountable surface and engages with a corner of the security container is sufficient to fix in place the safe. It is sufficient to protect the security container with a single bracket only, but this does not unnecessarily limit or prevent others from using two brackets if desired.

Another secure feature of the present invention is that the security container can be secured or removed from the docking bracket only when one knows how to open the main security container. Without first opening the security container, one cannot access the latching assembly within to either lock or unlock the security container once it is in place in the bracket. In other words, one needs to have access to the interior of the security container to either engage or disengage the latching assembly of the security container before one can remove the container from the docking bracket.

### Section I.—Docking Bracket

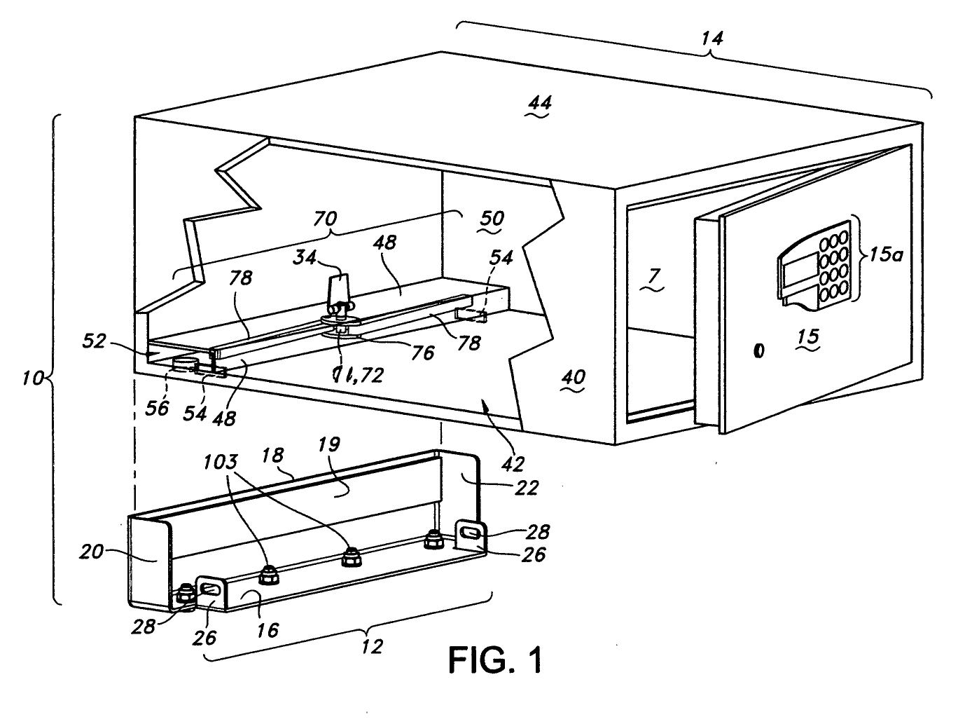

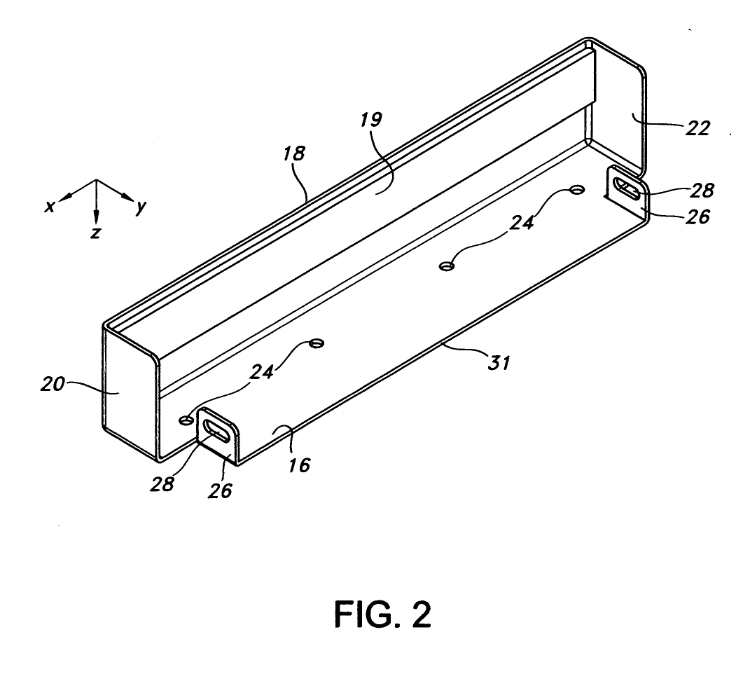

FIG. 1 is a general illustration of the security assembly according to the present invention. The security assembly 10 involves two major components a docking bracket 12 and a security container 14, such as a safe or lock-box. The docking bracket 12 can be secured or fastened permanently to a substrate surface 5, such as a floor, a wall, studs or ribs of either a building structure or motor vehicle. The docking bracket 12 is designed to engage and lock with the security container 14. As shown in FIG. 1, the components are positioned relative to each other such that the security container is lowered into the docking bracket. At a minimum, the docking bracket 12 is constructed with two major flanges, in particular, a first flange 16 and a second flange 18. As illustrated in FIGS. 2, 3 and 4, the docking bracket has a first major flange 16 that is oriented in a substantially orthogonal manner to a second major flange 18. The orientation of the angle between the flanges in this embodiment is substantially the same as or mirrors the angle of the faces of the side and bottom walls of the security container 14 that will sit against these respective major flanges of the docking bracket. A tight tolerance ensures proper alignment between the bracket and the security container. In addition, a small tolerance between the two interfaces restricts the potential range of motion between the bracket 12 and security container 14 during travel. When the gap tolerance between the docking bracket 12 and the security container 14 is close or the same, the ability to lift or pivot the security container 14 while it is engaged in the bracket 12 is decreased. A robber or vandal would need to apply a greater amount of force to torque the security container from the bracket interface. Hence, a potential robber is further deterred.

Typically, the docking bracket 12 has a third flange 20 that is paired with a fourth flange 22, which is oriented substantially orthogonal to both the first and second flanges. The third 20 and fourth 22 flanges are situated longitudinally at opposite ends of the first flange 16 and second flange 18, such that one is at each end of the docking bracket 12. The pair of end flanges 20, 22 helps to provide structural support to the bracket and additional security to the assembly. These end flanges provide torsional rigidity and integrity to the other two flanges of the bracket, preventing a robber from being able to deform or bend the first and second flanges away from each other, and thus wedging the security container free from its secure mounting. Additionally, the end flanges also shield the latching assembly that locks the security container in place and prevent access to the locking mechanism from the side of the bracket should one try to forcefully remove the security container by lifting up at an angle and trying to cut or saw through the engagement tabs 26.

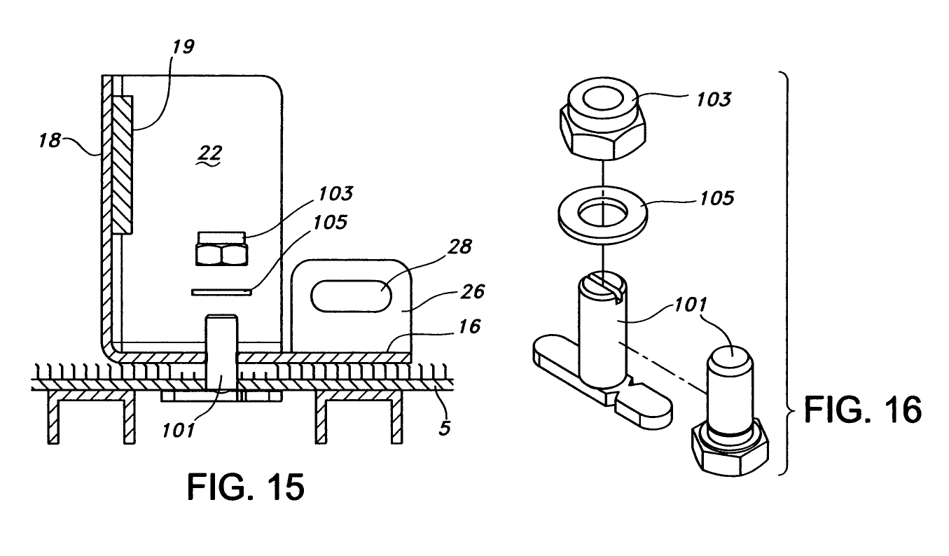

The docking bracket 12 has multiple features that permit it to be mountable to many different kinds of surfaces, while being able to enhance both the security and portability of a security container. The first major flange 16 is adapted to be secured permanently to the substrate 5, which can be, for instance, either a floor in either the passenger or cargo area of a vehicle (See, FIGS. 15 and 17) or a wall or floor of a building structure.

The docking bracket in the accompanying figures will be described in relation to an x-y-z-coordinate axes system. The width of the bracket corresponds to the y-axis; the length of the bracket corresponds to the x-axis; and the height of the bracket corresponds to the z-axis. In the accompanying FIGS. 2, 3, and 4, more specifically, the first flange 16 is oriented in the x-y plane, and the second flange 18 is oriented in the x-z plane. As will be described further, on each flange are disposed certain features that facilitate securing the security container 14 in the docking bracket 12.

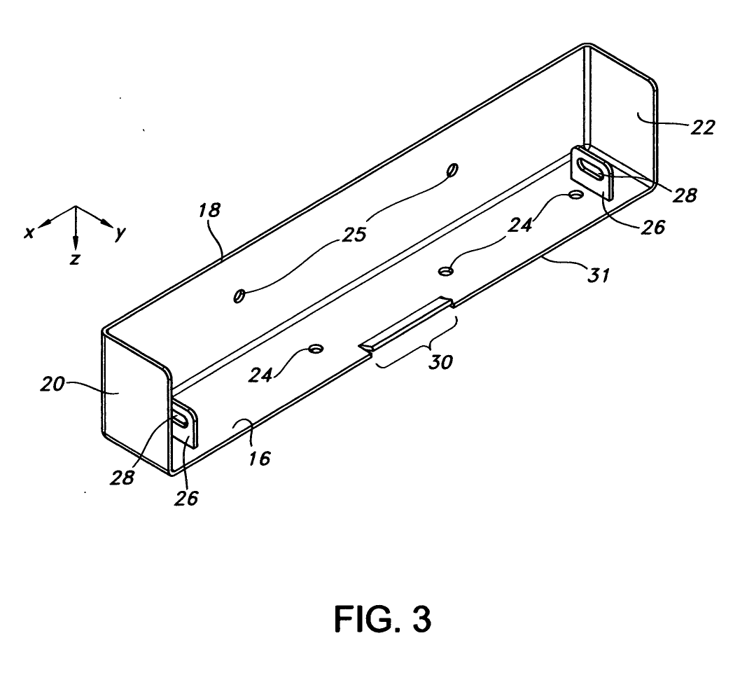

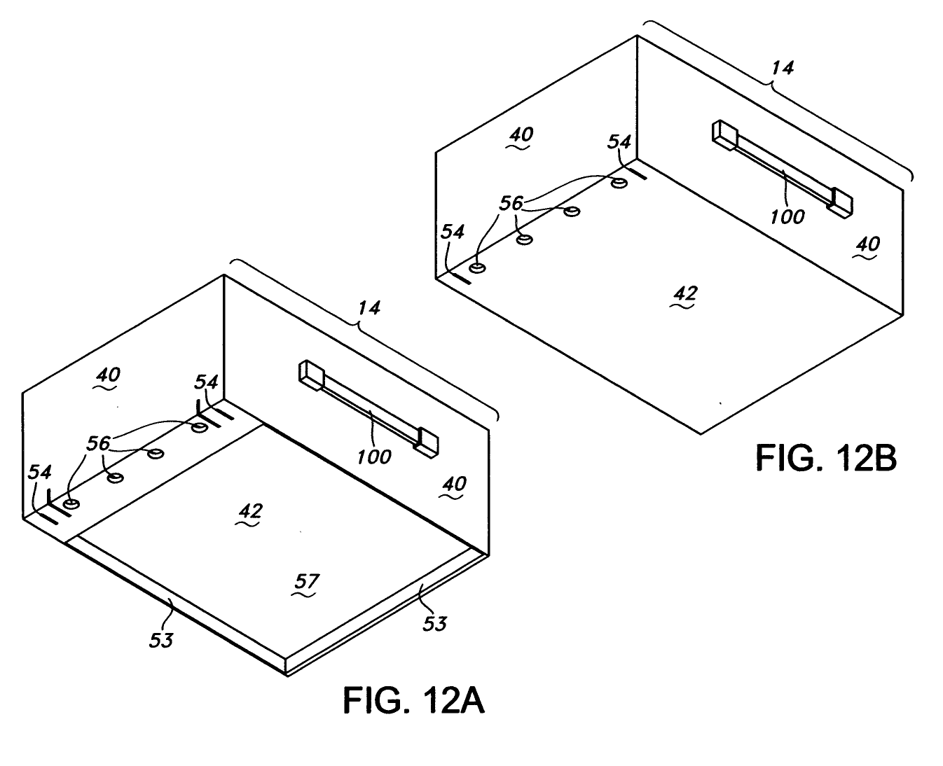

Extending from the plane of the first flange 16 is a set of protruding minor flanges or engagement tabs 26. Typically, the tab members are arranged as a matching pair disposed at either end of the docking bracket, as shown in FIGS. 1-4. The protruding tabs 26 extend upward out from the plane of the first flange 16 on the side opposite the side that faces toward or is in contact with the mountable substrate surface 5. In each protruding tab 26 is an opening or hole 28, through which part of the latching assembly in the security container may be inserted once the security container 14 is set into the docking bracket 12. Each protruding tab 26 on the first flange 16 is arranged to align with a corresponding hole 54 situated in the bottom 42 of the security container 14, as depicted in FIGS. 12A and 12B. As shown, the protruding tabs are located equidistant from the ends of the first flange 16, and oriented transversely to the longitudinal axis (x axis) of the first flange. This does not however preclude other arrangements according to the present invention. Also, the relative positions of the engagement tabs 26 on the first flange 16 can be adjusted along the transverse axis (y-axis) of the flange. As shown in FIG. 2, the engagement tabs 26 are situated more toward the edge 31 of the first flange 16 and away from the second flange 18. Alternatively, FIG. 3 shows an embodiment in which the engagement tabs 26 are placed centered or equidistant along the transverse axis between the edge of the first flange 16 and the intersection of the second flange 18.

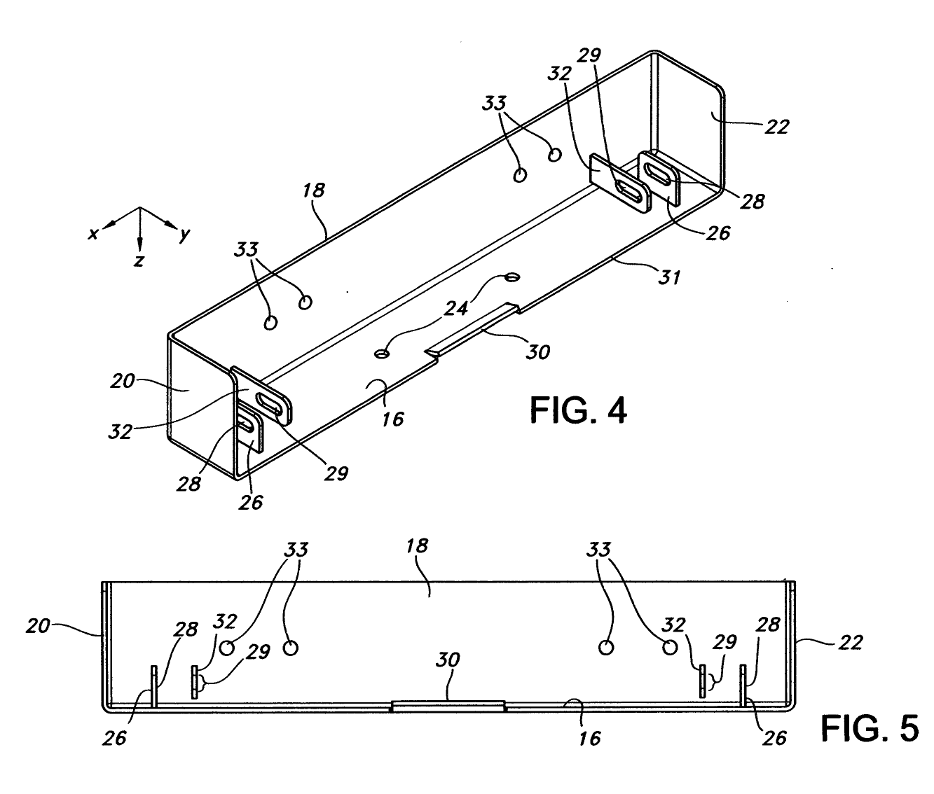

Shifting the placement of the engagement tabs along either x or y axis will alter the amount of force required to forcefully dislodge the security container from the docking bracket. For example, when the protrusions are orientated farther away from the seam where the planes of the first 16 and second 18 flanges intersect, a vandal must apply more force to the container 14 to remove the container from the bracket 12. More force is required because by placing the engagement tab 26 farther from the connection point of the two major flanges effectively shifts the leverage fulcrum closer to the applied force, accordingly reducing the mechanical advantage. Again, a preferably embodiment would maximize the amount of force necessary to dislodge the latch between the bracket 12 and security container 14. While an embodiment may have a combination of multiple engagement tabs on both the first 16 and second flange 18 shown in FIGS. 4 and 5, it should also be noted that other embodiments may have either flange to be configured with a single engagement tab. Such permutations of different configurations of single engagement tabs will still work cooperatively a whole to secure a container. Embodiments with a single engagement tab on a flange may be more applicable for an apparatus that is used for smaller security containers.

FIG. 2 shows in a perspective view of a docking bracket design according to an embodiment of the present invention. As depicted in FIG. 2, the transverse dimension of the first flange 16 is greater than the transverse dimension of the second flange 18. In comparing to the design illustrated in FIG. 3, the engagement tabs 26 are located closer to the edge of the first flange 16 than to where the first flange 16 meets the second flange 18. This configuration we believe will minimize a robber's ability to torque or jostle the security container, because the engagement tabs will sit underneath further toward the center of the security container when the container and bracket are joined. Similarly, in other embodiments such as depicted in FIGS. 4 and 5, a second set of engagement tabs 27 may protrude from the second flange 18, with its major dimension oriented along the transverse axis of the second flange.

In the embodiment shown in FIGS. 3-5, a raised lip-like protrusion 30 is situated in the center of the longitudinal axis (length) along an exposed edge 31 of the first flange 16 remote from the second flange 18. The lip-like protrusion 30 is a region of the major flange 16 that has been angled upward. The raise lip-like protrusion 30 is another security feature, which creates another point of engagement for a bend or hook 78 on the latching assembly to secure the container 14 to the docking bracket 12 and minimize a vandal's ability to remove the container by applying upward torque to the security container 14.

The docking bracket 12 is designed to be permanently fastened to a mountable surface 5, such as shown in FIG. 15. A number of holes 24 extend through the plane of the first flange 16 to permit one to fasten the docking bracket by the first flange 16 to the mountable surface 5. (Similarly, in certain other embodiments, a number of holes 25 that extend through the plane of the second flange 18 will permit one to mount the bracket by the second flange 18.) The user can have the freedom to determine which holes he will use to fasten the bracket to the mountable surface or when an alternative orientation is desired.

According to an embodiment, the holes 24 are spaced out equidistantly on center along the longitudinal axis of the first flange or second flange. Placing the holes (24, 25) equidistant allows the load on the bracket be equally distributed when multiple fasteners are used. In other embodiments, the holes may be spaced differently, with variable distance on center between each pair of holes. The fastening holes are reusable, such that if one needs to relocate the bracket, a user can employ the same method or fastener to attach the bracket to a new mountable surface.

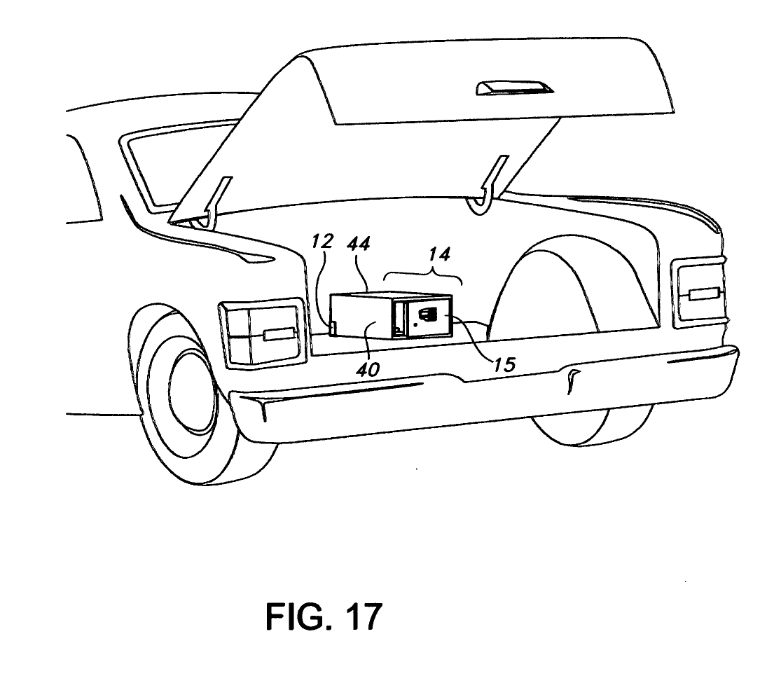

One can fasten the first flange 16 to the mountable surface 5 by various means. An appropriate fastening system that is adapted for use with different mounting surfaces can be employed to secure the bracket 12. Through the number of holes 24, 25 that are distributed in the either the first or second flanges 16, 18, one may bolt the bracket to the substrate 5 such as shown in FIG. 15. For instance, if the docking bracket 12 is to be mounted in a home or a commercial building, one can use an appropriate fastener, such as a wood screw to attach into a stud of a wall or use a separate frame or metal bracket and masonry bolts or screws to attach the bracket to concrete, cinder block, brick, stone or other like materials. In some embodiment, such as shown in FIG. 16, the bolt can have a frangible portion that can break off and thereby allow one to place the bolt close or next to a rib or joist in the vehicle or building without spatial hindrance. In other instances, one can spot weld a flange of the docking bracket to a compatible metal substrate, such as if the mounting surface is in a car or on a boat. A fastener for composite material or fiberglass substrates could also be used to bolt or screw the bracket into place on the interior mountable surface of the car or boat.

The security assembly may be used with a single bracket 12 according to an embodiment of the present invention. A single bracket saves space and affords a user greater flexibility in positioning and choosing what kind of substrate surface on which to mount the bracket 12. This nonetheless does not limit the invention, for one may also employ if desired a second docking bracket placed parallel to the first. In such a situation, the latching assembly to secure the security container to the docking bracket can be duplicated in an opposite end of the container.

Typically, the first and second flanges should similar dimensions (i.e. length, width and thickness). However, bracket embodiments that are attached to particular mountable surfaces facilitate differences in dimensions between the first and second flange. Constructing the bracket could be achieved using any metal forming technique. The bracket has been described as at least being composed of two flanges; such references are solely descriptive. For example, the docking bracket can be constructed by bending a metal sheet into orthogonal flanges. The bracket construction may also be achieved by welding to separate pieces of metal together.

As for methods of constructions, the particular technique used to form or join the two major flanges and end flanges of the docking bracket is not limiting. For instance, the bracket could be formed by bending a single piece of metal. Alternatively, one can join two pieces of metal together as long the bonding seam between the two flanges does not serve as a point of structural weakness for the bracket. The bonding point should have the same rigidity and strength. Desirably, the end flanges (20, 22) are made from the same material as the rest of the docking bracket. For instance, during fabrication, one may bend the end flanges (20, 22) from the same piece of metal that forms either the first or second major flanges of the bracket. A metal bending technique could be used to create a bracket with all four flanges from a single piece of metal. The dimensions of the end flanges preferably should be identical to each other. Alternatively, the end flanges can be separate pieces that are attached to the first and second flanges during construction of the bracket. The fabrication process used to attach the third and/or fourth flange should be sufficient ensure that the connection is not a structural point of weakness for the bracket.

Regardless of the method used to fabricate the bracket, as mention earlier, the tolerance of the angles of the joints of the first major flange 16, second major flange 18, and third and fourth flanges 20, 22 with the corresponding faces of the security container 14 should also be small—ideally the two surfaces of the bracket and security container should be parallel to each other, and with a gap of no more than about 3 mm-5 mm. In certain variants, the third and fourth flange may have a thickness that is greater than the thickness of each of the first and second flanges. This increased thickness of the third 20 and fourth 22 flanges can make it more difficult for a robber to gain access to the security container from the side.

FIG. 4 shows a three-quarter perspective view of an alternative design of the docking bracket, and FIG. 5 shows a straight-on front view of the same embodiment. Protruding engagement tabs 32 are located on the second flange 18. Similar to first flange 16, each engagement tabs has a hole 29. When the present security assembly is installed, these tabs 32 provide an extra measure of security by creating an additional point of attachment between the bracket 12 and the security container 14, and resistance to movement. Similar to the protruding flanges 26 on the first flange 16, the engagement tabs 32 on the second flange 18 can be oriented along the transverse axis or width of the second flange 18. In some embodiments, a set of button-like, protruding alignment disks or hemispheres 33 can also be located on the second flange 18. Although, the button-like disks are depicted as being round, their form is not limiting; such as they can be any shape (e.g., triangular, square or cubic, frusto-conical). The alignment disks 33 serve multiple purposes. First, the alignment disks 33 can be a guide when installing the security container into the bracket 12. Second, the alignment disks 33 can function as a motion inhibitor that prevents one from shifting the security container 14 out of alignment by applying force to lift or rotate the security container. A tight fit between the bottom and side walls of the security container and the major flanges at the point where the first and second flanges of the bracket meet is desirable. In certain embodiments a compressible strip or pad 19 may be incorporated to help maintain the tight fit. An example of such a pad 19 is positioned on the second flange, as depicted in FIGS. 1, 2, and 15.

As depicted in FIG. 1, the docking bracket should be of an appropriate and comparable size to accommodate the security container snugly, with virtually no allowance for movement or wiggle once the container is set in the docking bracket. For instance, in an embodiment, the inner dimension of the bracket between end flanges (20, 22) can be approximately 18.1, 18.5 or 19 inches in length to fit a security case 14 having either a length or width dimension of about 18 inches. The second flange 18 should have a height that is sufficient to prevent the container from tipping free if when the remote end of the security container away from the end engaged within the docking bracket is tipped upward. In certain embodiments, one can ascribe a dimensional ratio of between about x:3x up to about x:10x, typically between about x:3.5x or 4x up to about x:5x or x:7.5x, wherein x represents the height of the second flange of the docking bracket and 3x, 4x; 5x, 6x, or 10x is the represents the relative height of the security container docked in the docking bracket. Thus, for example, the second flange that has a height of about 2 inches can work well with a security container having a height dimension of between about 6-8 inches and about 16-20 inches.

### Section II.—Security Container

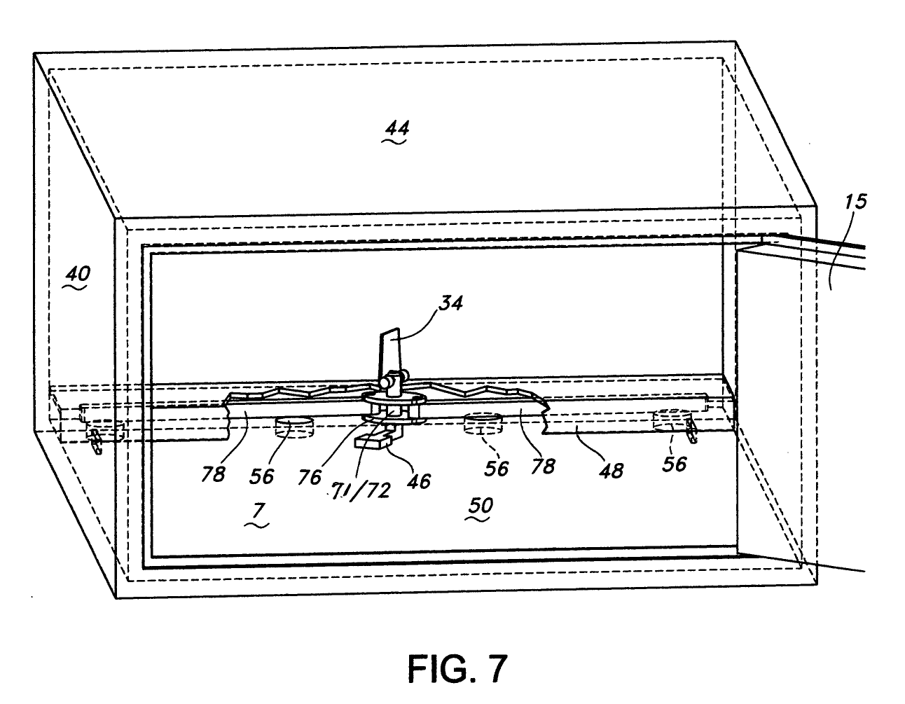

The other major component of the security system is a security container having a housing as defined by least a side wall 40, a bottom wall 42, and a top wall 44 or cover, all defining an interior space. The interior space, according to the present invention, is separated into least two compartments or chambers. A larger first compartment 50 serves as the main storage space of the security container and a smaller second compartment 52 houses a latching assembly 70. Accompanying FIG. 7 shows a view of the interior space of the security container through an opening and a partial cut-away view of the second compartment actuating switch 34.

### A

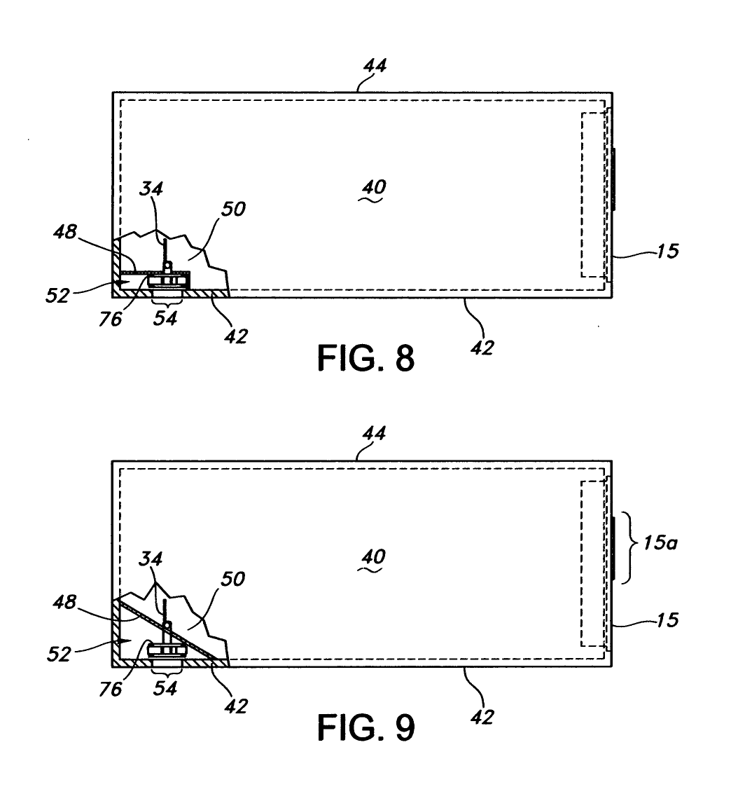

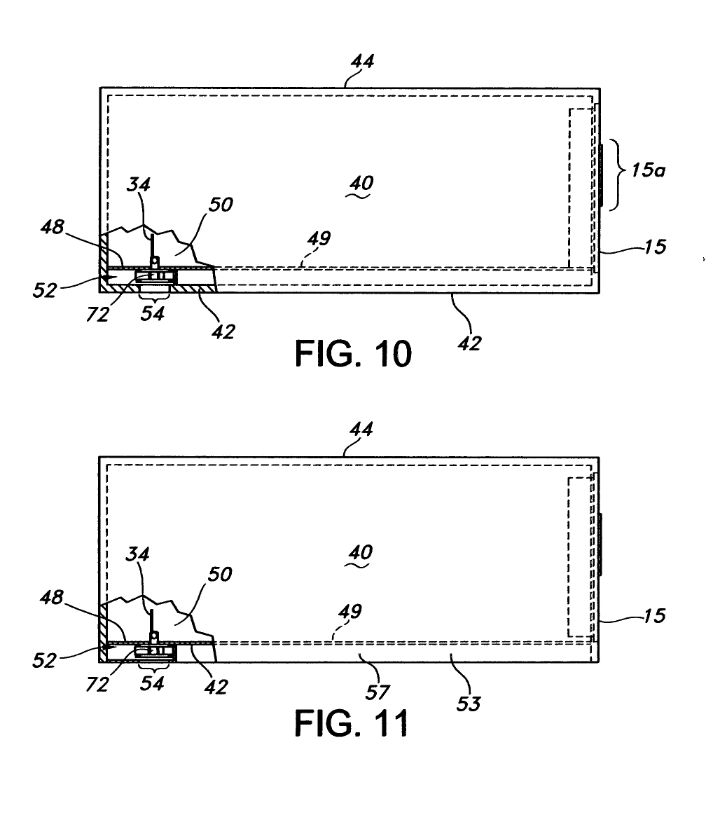

The two compartments of the container are separated by a barrier 48, which serves as a divider between the first compartment 50, which is for housing valuables, and the second compartment 52, which houses the latching assembly and its actuating mechanism. When the second compartment 52 is divided from the volume of the first compartment 50, the barrier 48 is raised from the floor of the security container, such as shown in FIGS. 8 and 9. In other embodiments, when the second compartment 52 is situated underneath the first compartment, the barrier 48 could constitute either the entire or a part of the floor or bottom part of the first compartment 50, such as illustrated in FIGS. 10 and 11, respectively. In this latter configuration, the floor of the first compartment is level and only the handle of the latching assembly is seen protruding though the floor of the first compartment 50 in the container.

Access to the first compartment 50 from the outside is through an opening 7 that can be situated either on a side or the top of the security container 14. As shown in FIG. 1, 6 or 7, which are three-quarter perspective view of the security container, the opening is on a side and closed with an exterior door 15 or cover. In other embodiments, the security container door 15 can be situated on the top of the container 14. The exterior door 15 has a locking mechanism 15a. Various styles of locking mechanisms for the door are contemplated, ranging from a simple mechanical lock and key configuration, to a computerized, digital, remotely accessible, or biometric-based lock system. The particular selection is not intended to be limiting. An example of a locking mechanism is a lock having pins, wheels or tumblers that operatively actuate a bolt in response to a predetermined sequence of operations. The locking mechanism is operatively actuated by a lock actuator for locking and unlocking the locking mechanism. The lock actuator may be any type of identification device. The lock actuator may be password protected; for instance, the lock actuator may be a keypad for receiving a corresponding security code to either activate or deactivate the locking mechanism. Other examples of a lock actuator may be a rotary dial, a key, a digital key, a card reader, a bio-identifier that relies on a physical identifying characteristic of the user, such as a fingerprint, a retinal eye scan, voice recognition, or the like. Alternatively, the door can be operated by means of a remotely controlled activating device. If the locking mechanism is any one of the more technically complex variety, the security container also can have a fail-safe mechanism to unlock the container should something malfunction with the computerized lock system.

Since the primary purpose of the security container is to protect any valuables (e.g., money, computer, documents) or to secure any potentially dangerous objects (e.g., guns, knives) inside, the walls of the container should have a sufficient thickness to prevent easy access or damage to the interior. The typical container should be sufficiently strong and thick to be able to withstand or prevent being easily punctured or cut open with simple hand tools, such as a drill or hacksaw. The walls of the container can have a thickness of between about a quarter inch up to about one or two inches. The thickness typically will depend on the type of material used to construct the container 14, which can be selected made from a variety of materials. For instance, the security container typically can be made from hardened or reinforced steel or steel alloy, cast iron, or some other form of durable metal or metal-based material, as with other conventional safes or lock boxes, or alternatively, a durable heavy plastic, a ceramic, a composite material or the like. The material used in the security container housing should maintain the structural integrity of the container. For example, the material should be able to withstand a certain predetermined temperature level, so as to protect the contents from fire, or a certain predetermined amount of force when applied against the container walls.

In order to provide more security for the valuables, a variant of the security container would protect the valuable in case of fire or water. In the case of fire the particular composition such that it does not deform under the conditions of a typical fire. An embodiment of the security container may be rated UL (United Laboratories) 72 or 125. Such ratings indicate that the internal temperature of the security container would not rise above 72° F. or 125° F. This rating would insure that the container could hold valuables, papers as well as data storage mediums compact disks or magnetic tape. The security container can also meet sufficient water proof standards such that documents, computer readable data or valuables would not be damage if the container was submerged for an extended period of time (i.e., about an hour).

The invention was configured to ease portability and secure valuables. Thus if a horrific accident were to occur involving fire or water, the user would probably want assurance that their valuables would be secure.

### B

For sake of portability and ease of transport, the security container 14 should have an overall size and dimensions that are not unwieldy for a user to handle, and should allow the user to be able to move the container 14 easily and readily once the container is disengaged from the docking bracket 12. In certain embodiments, for example, the security container can have width dimensions in a range of about six inches or about 12 inches (˜15 cm or ˜31 cm) up to about 36 inches or about 40 inches (˜91 cm or ˜102 cm), and a length of substantially equal dimensions, or it can be rectangular with a length of up to about 60 inches or 72 inches (˜154 cm or ˜183 cm), and/or any other combination of dimensions therein between. These general parameters do not necessarily limit the possibility that either or both the docking bracket and security container can be of any reasonable or suitable dimensions, as long as the container and docking bracket have dimensions that are congruous and complimentary to each other. Typically, for example, the security container 14 can have dimensions similar to a suitcase of about 24 inches (˜61 cm) or 32 inches (˜82 cm) long and about 16 inches (˜40 cm) or 18 inches (˜46 cm) wide. The overall height of the container can range between about two or three inches up to about 18, 20, or 22 inches. Typically, the practical height of the container's interior compartment desirably can be between about 5, 6 or 8 inches to about 10, 12, or 15 inches, while making allowance for the thickness of the top and bottom walls will increase the overall height.

### C

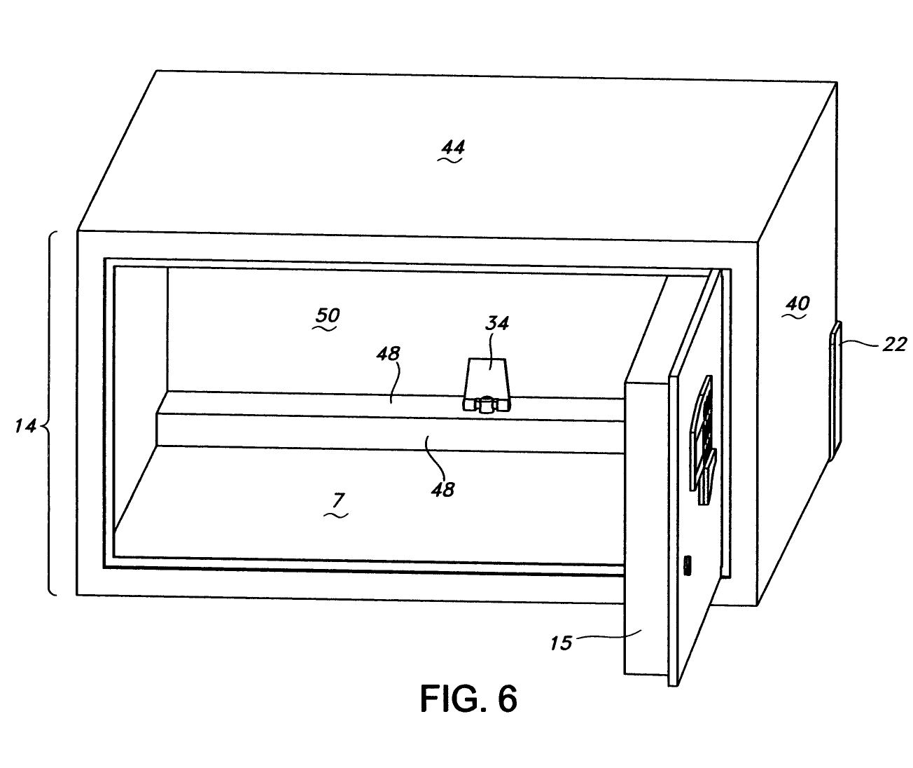

To lock the security container 14 with the docking bracket 12, the present invention employs a latching assembly 70 that is housed in the second compartment 52. The latching assembly includes a locking mechanism that extends and retracts once the security container and docking bracket are engaged with each other. In a basic form, the latching assembly of the present invention is centered on a rotary hub or pivot 72. The hub is oriented vertically along the z-axis, around which the other components of the latching assembly move. At the upper or top end the axis is connected to a switch handle 34 that the user can turn to actuate the latching mechanism. When the security container is assembled, the handle 34 is configured to be the only portion of the latching mechanism that is visible and accessible from the interior of the security container, such as depicted in FIGS. 6 and 7.

In the embodiment shown in FIGS. 6 and 7, the handle is rectilinear or trapezoidal in shape. This does not necessarily limit the shape of the handle as long as the configuration would permit the user to achieve sufficient dexterity to turn the handle. The switch handle 34 can also collapse to prevent obstructing or interfering with storage in the first compartment 50 by rotating the handle around the pivot 72. The handle and pivot can be made out metal or another material. The handle 34 and a flexing or rotating carousel member 76 should have sufficient material integrity and strength so that they do not break from material fatigue or malfunction under repetitive use.

As shown in the accompanying figures, the handle and carousel are situated equidistant from the lateral sides of the security container 14, which conforms to the longitudinal axis of the docking bracket 12. Placing the handle 34 in the center of the barrier wall 48 allows the actuating mechanism to be symmetrical. A symmetrical actuating mechanism implies that the engaging rods have the same dimensions. In other embodiments, the handle may be offset along the longitudinal axis. If the handle is offset, a corresponding change in symmetry would be applied to the actuating mechanism. Such an adjustment to the actuating mechanism would be necessary to ensure that engaging rods engage properly with the engagement tabs 26 of the docking bracket 12.

In an embodiment, a recess or niche cavity 37 is countersunk into the barrier wall 48. This feature permits the user to rest or store the handle 34 flush with the surface of the barrier wall 48 after use. An embodiment that allows the handle to rest flush with barrier requires a feature to pull up the handle 34 from its resting position in the recess 37. A finger hole or lip could be situated in the handle 34. When the handle is stored flush the user could place their finger in the hole or lip and use leverage to rotate the handle 34 up into a vertical position.

FIGS. 8-11 show a cut away view of various configurations of the barrier wall 48. Practically, the first compartment 50 is desirably larger than the second compartment 52. Nonetheless, the placement of the barrier 48 in the container may allow for potential embodiments in which the first compartment is smaller than the compartment housing the actuating device 70. FIG. 8 shows the second compartment 52 situated in a lower corner of the larger first compartment 50, while FIG. 9 shows an alternative configuration of the same concept.

As a degree of versatility in the different embodiments, the different configurations can be employed to optimize the space of the first compartment 50 in the security container. Hence, the second compartment can be situated underneath the main first compartment. The embodiments in FIGS. 10 and 11 depict the barrier wall 48 as a divider between the first compartment 50 and second compartment 52, as well as being the bottom or floor 49 of the first compartment 50. In FIG. 10, the barrier wall 48 extends the entire area of the container and is enclosed within an exterior bottom wall of the container, forming a false or double floor. In FIG. 11, the barrier wall 48 serves as an external bottom wall of the first compartment. A side flange 53 drops down below the level of the floor to help conceal the second compartment that is suspended from the barrier wall as well as level the container. In other words, addition of the flanges 53 at the bottom of the security container ensures that the security container 14 will not wobble and that the security container 14 can be properly aligned in the docking bracket 12. As illustrated in FIG. 12A, the side flanges 53 and the bottom wall of the container 42 defining a hollow space 57.

FIG. 12A depicts a bottom view of the security container according to an embodiment of FIG. 11. As shown the hollow space 57 is bounded by the second compartment 52 and on the three other sides by three contiguous flanges 53. In other embodiments, one or two flanges can suffice as long as the security container is level. A flange 53 should be of sufficient thickness and sturdiness to be able to support the weight of the container 14 along with the second compartment 52.

Also as shown in FIG. 12A, on the outside of the security container, one or more straps or handles 100 can be located. This handle helps the user easily carrying the container once it is disengaged from the docking bracket. Also a number of holes 56 are shown in the underside of the second compartment 52. These holes correspond to the tops of the bolts or screw heads that secure the docking bracket to a mounting surface. The holes 56 permit the bolt or screw heads to fit through the bottom of the second compartment when the container rests within the docking bracket. This configuration ensures that the security container sits level when locked in place.

A carousel member 76 with either an elongated or rounded form, typically an ovoid or elliptical form, is attached to and centered on the vertically oriented pivot 72. An engagement rod or shaft 78 extends from each elongated or parabolic-shaped end of the carousel toward the side or longitudinal ends of the second chamber. These engagement rods are connected by a pivoting bolt or rivet to the carousel at a first end and are free at their other second end. This arrangement permits the engagement rod to turn relative to the carousel. The second end of the rod may be aligned with a channel or groove 80 in the rod and a pin to help guide the second end through the opening 28 of each of the respective engagement tabs 26.

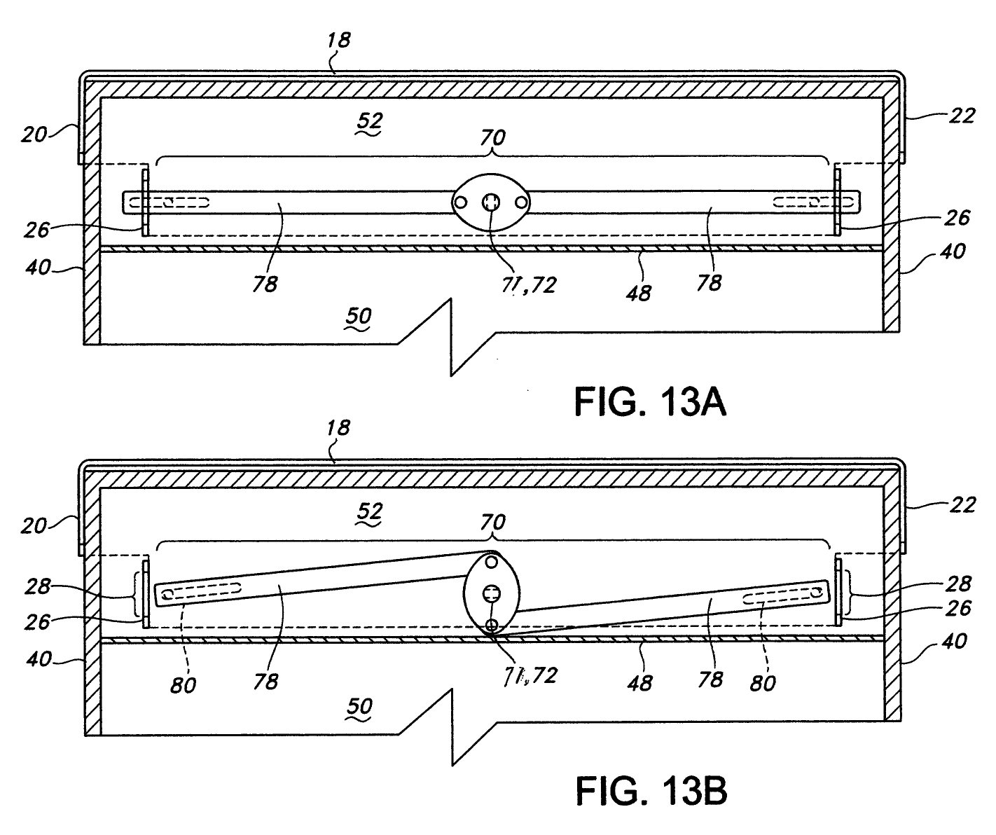

FIGS. 13A and 13B depicts a top-down, cutaway view of the interior of the security container showing the first and second compartments and an embodiment of the latching assembly 70. FIG. 13A shows the locking mechanism in its locked position, with the engagement rods 78 extending through the holes 28 in the engagement tabs 26 on the first flange 16. FIG. 13B shows the engagement rods retracted from the corresponding engagement tabs. The engaging rods should be rigid members, typically the rods the can be made of a kind of metallic material that is not easy to bend or otherwise deform. The engagement rods can have any cross-sectional profile. Typically, the rods can have circular or ovular, or astral-shaped cross-sections. This does not limit the rods from having either triangular or rectilinear or square-like cross-sections. When the rods 78 are extended to engage with the holes (28, 29) in the protruding engagement tabs (26, 32) of the first and second major flanges, the rods 78 should be able to pass easily through the holes (28, 29). Ideally, the tolerance between and engaged rod 78 and the hole it rests in should be minimal.

The latching assembly in the second compartment of the security container, according to an embodiment, may include a counter-motion mechanism that is designed to help with the turning of the rotating hub and the engaging rods. Such a counter-motion mechanism can be actuated with one or more springs in various configurations or combinations.

In certain embodiments such as illustrated in FIG. 7, at the lower end of the vertical axis, opposite and distant from the handle 34, is a hook or latch 46 that is designed to engage with the lip-like protrusion 30 of the docking bracket. As shown, the end of the latch has a T-shaped extension that can hook under the lip. Since the lip 30 is raised at an angle relative to the plain of the first major flange 16, for example about 30 degrees to about 45 degrees, the angle should be sufficient to permit a hook or latch 46 to rotate into place and easily engage with the lip protrusion when the actuating mechanism is in its locked position. The engagement of the hook 46 and the lip-type protrusion 30 secure the latching mechanism in a locked position and prevents one from over exerting the latching mechanism, and may make it more difficult for one to lift the security container 14 from off of the docking bracket 12. When the latching mechanism is unlocked to disengage the engagement rods from the docking bracket 12, the hook also disengages from the lip-type protrusion. In other embodiments, the hook 46 could be attached to the carousel 76 instead of an axial pin 71.

### D

In alternative embodiments, the latching mechanism 70 can have a number of springs to help either open or close the latching mechanism. The springs can be either tension springs, torsion springs or compression springs. Potential energy is stored when a tension spring is elongated (stretched); when a compression spring is deflected (compressed); or when a torsion spring is rotated about its central axis and the ends are fixed. When the stored potential energy is released the springs return to their natural state (i.e., state where no force is applied to the spring). As the springs return to their initial state, they either push/pull the actuating mechanism. The springs should be able to push/pull the actuating mechanism because at least one end of the spring is connected to the actuating mechanism. Depending on the configuration, the other end of the spring may be attached to the actuating mechanism or an interior side of the second compartment 52. The mechanism can make use of either a single spring or two counter-aligned springs strategically positioned to assist the user to either lock or unlock the latching assembly. Some embodiments may include counter-aligned springs that are positioned on either side of the central hub. For instance, counter motion compression of the springs draws the springs together when on wishes to disengage.

According to yet another embodiment, the actuating mechanism of the latching assembly includes a spring counter-motion apparatus that helps maintain the latching assembly in a locked position when one places the security container in the docking bracket.

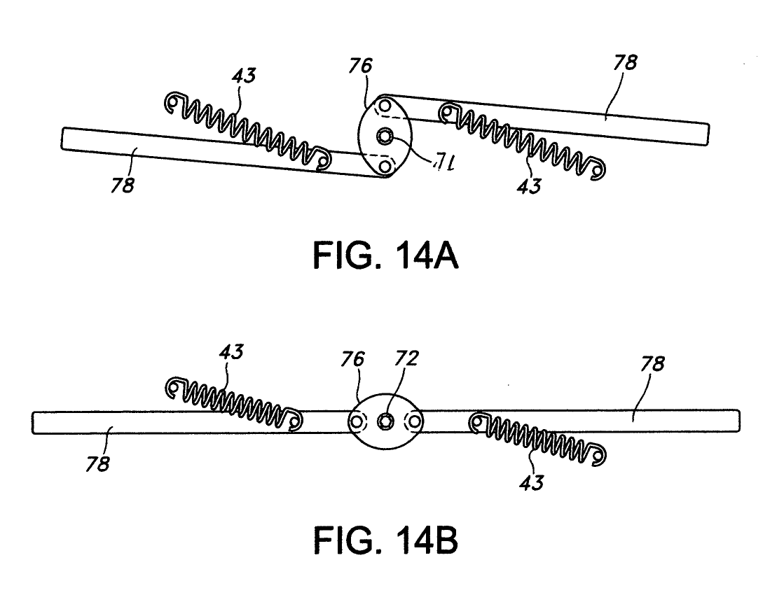

The spring can also be attached so that it strengthens the engagement force. An embodiment is illustrated in FIGS. 14A and 14B. FIG. 14A is a top down view of the latching mechanism in an unengaged state, while FIG. 14B shows the actuating mechanism in an engaged state. A strengthen engagement force insures that the actuating mechanism 70 does not unintentionally disengage the rods 78 from the bracket 12. Variant configurations can use spring alignments that provide the advantage of effective disengagement and the advantage of strengthened engagement. can use It should be noted that the strength of the spring should be sufficient to provide mechanical advantage to the desired motion of the user without counteracting the actuating mechanism, causing the actuating mechanism to engage or disengage.

The configuration of a spring can be attached so that the actuating mechanism 70 will effectively disengage from the bracket. In other embodiments one can arrange the springs to help open the latch. Using a spring can increase the mechanical advantage for the user when they seek to disengage the security container. Effective disengagement occurs when the user turns the handle to disengage the rods 78 from the protrusions in the bracket 12, and the motion of the engagement robs is not encumbered or impeded as the actuating mechanism returns to the disengaged position. Depending on the alignment and type of spring used, the spring will push/pull the actuating mechanism back to the disengaged state.

Alternatively, according to certain embodiment, at least one spring elongates when the actuating mechanism engages and disengages. When the pin 71 is turned causing the carousel member 76 to rotate, the engagement rods 78 extend into the holes 28 in the engagement tabs 26 of the first flange 16, or in other embodiments the holes of both engagement tabs 26, 32 of both the first flange 16 and second flange 18. In this embodiment, a spring 43 elongates while as the rods 78 extends to engage the tab 26. One of the ends of the spring 43 is connected to the engagement rod 78. The other end of the spring is connected to either the carousel 76 or the surrounding structure of the barrier wall 48 or side wall.

An angle alpha (α) is defined by the spring and the length of the rotating member. In a natural state, the angle alpha could be less than 90 degrees. The initial length of the spring is a length beta (β). When the user turns the latch handle 34, the actuating mechanism 70 extends the engagement rods 78 outward, causing the attached spring 43 to elongate to a length β+x. The angle α can open 180 degrees when the actuating mechanism 70 engages the bracket 12. As the spring 43 is elongated during engagement there is slight tension exerted which seeks to disengage the actuating mechanism. The tensile force exhibited by the spring is due to the increase in potential energy.

Due to the alignment of engagement rods 78, the tension exerted by the springs 43 will only impact the actuating mechanism as it disengages (i.e., the tensile force of the spring will not be strong enough to disengage the actuating mechanism when the rods 78 are in the holes 28). Once the latch is turned to disengage the engagement rods 78, the spring 43 will seek to return to its initial state, eliminating any potential energy in the spring. The advantage of this spring configuration is that it ensures that the actuating mechanism disengages effectively. As the spring 43 returns back to its initial natural state it will pull on the rod 78, aiding the actuating mechanism to disengage. It should be noted that the use of springs in this configuration is not limited to a single spring.

Other embodiments may involve one or multiple springs in various arrangements. Multiple springs can be attached so that they are counter balanced on both sides of the rotating carousel. The additional spring increases the mechanical advantage.

In a variant embodiment of the first spring loaded actuating mechanism, one end of the spring is attached to the engagement rod and a second end is attached to the hub of the rotating carousel or barrier wall. This arrangement permits one to either optimize the force needed to engage or disengage the actuating mechanism. The variation is in the in the state of the spring when the actuating mechanism is disengaged. In this embodiment, the spring is in compression when the actuating mechanism is disengaged. The spring is aligned such that when the latch is turned to move the engagement rods to engage the tabs. The advantage of this embodiment is that the spring is now aligned to strengthen the engagement. A compressive force on the engagement rods would now be necessary to disengage the container from the bracket.

In a configuration that allows effective disengagement using a compression spring, an increase of the mechanical advantage during disengagement can also occur if compression springs are used instead of tension springs. For compression springs, they must be aligned in a different configuration than the tension springs, since potential energy is built by compressing the spring instead of elongating it. The orientation of the spring is defined by the spring and the engagement rod 78 with an angle sigma (a). When the handle 34 is turned to activate the actuating mechanism, engagement rods extend and compress the spring. Initially, in the disengaged state the angle sigma is less than 90 degrees. As the rod 78 moves to engage the docking bracket, the angle delta will decrease. The natural length is beta; when the spring is compressed during engagement the spring's length compresses to a length represented by β−x. When the actuating mechanism is disengaged, the potential energy is released and the compressed spring returns to its natural state. Again, as the spring returns to its natural state, it places a force on the engagement rods to push it back into the disengaged state. It should be noted that the use of springs in this configuration is not limited to a single spring. Multiple springs can be attached so that they are counter balanced on both sides of the rotating carousel. The additional spring increases the mechanical advantage.

In a variant embodiment of a single-spring loaded actuating mechanism that strengthens the engagement between the security container 14 and the docking bracket 12. The impact of this configuration is that it takes a greater force to disengage the security container from the bracket because a greater force is necessary to compress the spring. In seeking to insure that the actuating mechanism does not unintentionally disengage, a spring configuration can fortify the engagement between the bracket 12 and the security container 14. Placing a spring on the actuating mechanism that compresses when the actuating mechanism is transitions from the engaged to the disengaged state also increases the potential energy in the spring. An angle gamma (γ) is defined by the spring and engagement rod 78. When the actuating mechanism is turned from the engaged state to the disengaged state the angle gamma should decrease and the spring should return to its natural uncompressed state. That potential energy is also released when the user engages the security container with the docking bracket. The released potential energy will cause a force to push the engagement rods 78 into the engagement tabs 26 in the docking bracket 12. As before, it should be noted that the use of springs in this configuration is not limited to a single spring. Multiple springs can be attached so that they are counter balanced on both sides of the rotating carousel. The additional spring increases the mechanical advantage.

In an alternative embodiment that enhances the engaging force one can use a spring in tension instead of a spring that is compressed. A spring in tension can be aligned to exhibit a force that enhances the engaging force between the bracket and security container. An angle psi ψ is used to name the angle defined by the spring and engagement rod 78. In the embodiment, a spring is in the natural state when the actuating mechanism is engaged. When the actuating mechanism is moved the disengaged stated the angle theta should decrease. The spring length shall elongate to a distance β+x.

In an alternative embodiment, a torsion spring is used to enhance the mechanical advantage of the engagement mechanism. Using a torsional spring with one end fixed to the pin 71 and the second end attached to the engagement rod 78, the central axis of the torsional springs helical shape is wrapped around the same hub pin 71. When a user turns the latch, the pin 71 causes the engagement rod 78 to extend from the disengaged state to the engaged state. The extension of the rod causes the torsion spring to rotate through an angle θ theta; this action also causes potential energy to be build-up in the torsional spring. When the actuating mechanism is engaged with the docking bracket, the torsion spring has built up potential energy will be released when the user disengages the actuating mechanism. When the spring returns to its natural state, the potential energy is released and the spring will exert a pulling force on the engagement rods. It should be noted that the potential energy built up in the spring during engagement should not be significant enough to cause the rods to disengage from the bracket. But, multiple springs can be attached so that they are counter balanced on both sides of the rotating carousel. The additional spring increases the mechanical advantage.

By switching the direction of the helical coils of the spring, the user can gain a mechanical advantage that increases the amount of force necessary to dislodge the engagement rods 78 when they are engaged with the bracket 12. Reversing the direction the force applied during the release of potential energy should be caused by rotating the helical coils by 180 degrees. The reversal will cause the potential energy to building the potential energy when the rods are disengaged from the tabs of the bracket. The natural (un-torqued) state for the spring should be when the rods are engaged. Thus, a greater force would be required to cause the rods to dislodge; the dislodge force would also have to exert a force on the torsional spring.

Optimizing the alignment of the springs will allow the user to get the benefit on increasing the mechanical advantage when disengaging the actuating mechanism and increasing the force needed to dislodge the security container. Embodiments that have multiple springs can be aligned to optimize the needs of the user. This combination should both increase the amount of force necessary to disengage the security container but once it is designed, the actuating mechanism will disengage effectively. The length of the engagement rod is defined by the variable lambda (λ). In a configuration that uses a combination of one or more of compression, tension or torsion to achieve the desired results. In reference to the foregoing discussion, angles α, γ, σ, ψ, θ may be optimize to align the springs to achieve these advantages. In addition, ends of the springs that are attached to the engagement rods could be optimized by calculating their placement along the length λ of the engagement rod. This configuration should allow for instances in which the springs are allowed to work without counteracting the other. This may be achieved my attaching the springs at different points along the length (λ), such that the motion of the rod does not automatically cause a change in length or rotation in a spring.

Section III.—Engagement of Security Container and Latching Assembly with Docking Bracket

One of the conveniences of the present security container assembly is the ability of a user to remove the safe from the docking bracket and take it with the user. For example, if the bracket is mounted in a vehicle, the user can remove the safe from the vehicle and store it at home or business. If properly installed, the safe is latched or unlatched by means of a mechanism located inside of the security container. This latching mechanism can be activated only from the inside of the safe, when the safe is open.

Before mounting and securing the safe, one should verify that the latching mechanism is disengaged, and in an open or unlocked position. Typically, the alignment and placement involves the security container being held just above the docking bracket and placed in a substantially vertical, downward direction, such that the protruding flanges or tabs 26 are inserted into the holes 28 of the second compartment of the security container. Each engaging element on the bracket is inserted through a corresponding opening of the container into the second compartment to engage with the locking mechanism of the latching assembly housed therein. In operation, the security container should be centered between the side flange guides of the docking bracket, and once the security container is in the proper position, the container is lowered and placed onto the docking bracket. The security container should sit level with the docking bracket with the engaging elements or tabs fitting into locking pin slots on the bottom side of the container. Although some minor adjustments are allowed, the placement of the security container into the docking bracket should involve minimal lateral or horizontal movement of the safe box.

With the main door of the security container open, the user can reach inside the safe and turn the locking mechanism (e.g., 90 degrees clockwise), which will extend and engage the locking pins with the protruding flanges or tabs on the docking bracket. Now the safe is secure to the bracket. To disengage the security container from the bracket, the user can turn the locking mechanism in reverse, which will withdraw the engagement rods from the tabs.

The actuating mechanism 70 is the part of the security container 14 that engages the container to the docking bracket 12. By turning a pin 71, the handle 34 activates the actuating mechanism 70, which rotates the carousel 76 and extends the engagement rods 78 to the side toward the corresponding engagement tabs 26. The operation of the actuating mechanism begins with the

[symbol]

The operation of the latching assembly begins with a rotating pin 71 at the hub of the actuating mechanism that passes through the barrier wall 48 near the bottom of the security container 14. As the user turns the handle 34, the handle turns the pin 71. The rotation of the pin 71 causes a rotatable carousel 76 to move. The carousel 76 is attached to engagement rods 78. As the carousel member 76 rotates, the engaging rods 78 extend outward from their initial withdrawn position. In one embodiment, the engagement rods 78 insert through the holes 28 in the engagement tab protrusions 26 of the first major flange 16. In another embodiment, the engaging rods are inserted into the holes 28, 29, respectively of the engagement tab protrusions (26, 32) in both the first 16 and second flanges 18 of the docking bracket. In other embodiments, the engagement rods interact with the holes 29 when only the tabs 32 of the second flange 18 are present. In certain embodiments, additional security can be enhanced by a latch or hook 46 that is situated at the bottom end of the pin 71. As the pin 71 rotates, the hook 46 rotates and engages with the lip-like protrusion 30 on the first flange 16, which presents the pin from over-rotating. This further secures the security box to the bracket 12. The latch prevents the security container from lifting off of the mounting bracket. In other embodiments, the latch 46 could be attached to the rotating carousel member 76 instead of the pin 71.

The present invention has been described both in general and in detail by way of examples. The individual features described in any of the foregoing embodiments and examples should not be construed as unnecessarily limiting or preclusive of other features that are not mutually exclusive, but rather the features can be combined in various permutations of the present invention. Persons skilled in the art will appreciate that the invention is not limited necessarily to the specific embodiments disclosed. Modifications and variations can be made to the present security assembly without departing from the spirit and scope of the invention as defined by the following claims or their equivalents. Hence, unless changes otherwise depart from the scope of the invention, the changes should be construed as being included herein.

We claim:

1. A security assembly comprising:
A docking bracket having a first flange and a second flange, said first flange being oriented in a substantially orthogonal angle relative to said second flange,
said first flange having a number of holes through which a fastening element can secure said first flange to a mountable substrate surface, and an engagement tab member that extends from a plane of said first flange;
A security container having a housing with a bottom wall, a side wall, and a top wall or cover, all defining an interior space, a rigid barrier wall that divides said security container into a first compartment and a second compartment;
said second compartment containing a latching or actuating mechanism comprising a number of engagement rods that are linked to a flexing or rotating member, where said rotating member is connected to a switch situated on said rigid barrier wall, said second compartment having a number of holes in an exterior wall;
said security container is adapted to engage with said docking bracket, such that said engaging members of said first flange are inserted into said holes in an exterior wall of said second compartment, and said engagement rods interact with said engagement tab members after activation of said actuating mechanism.

2. The security assembly according to claim 1, wherein said switch rotates a pin through said barrier wall to activate a rotating carousel member to extend said engagement rods into said engagement tab members of said first flange.

3. The security assembly according to claim 1, wherein said holes in said exterior wall of said second compartment is situated in a bottom wall.

4. The security assembly according to claim 1, wherein said first compartment is larger than said second compartment.

5. The security assembly for claim 1, wherein said second compartment is suspended underneath said first compartment.

6. The security assembly according to claim 1, wherein said barrier wall forms part of said bottom wall and a floor of said first compartment.

7. The security assembly according to claim 1, wherein said switch is foldable into a recess in said barrier wall.

8. The security assembly according to claim 1, wherein the second flange of the docking bracket provides a second set of engagement tab members that inserts into a complementary set of holes in said side wall for security container.

9. The security assembly according to claim 1, wherein said docking bracket has a third flange and fourth flange situated on opposing ends of said first and second flanges and are oriented orthogonal to the first flange and second flange.

10. The security assembly according to claim 1, wherein at an end of a rotatable hub opposite said switch is a latch that is adapted to engage with a lip-like protrusion on said docking bracket.

11. The security assembly according to claim 1, wherein said container has an exterior door that provides access to the first compartment and a locking mechanism for said exterior door.

12. The security assembly for claim 9, wherein locking mechanism can be activated either manually or remotely.

13. The security assembly according to claim 1, wherein the engagement rods is spring loaded.

14. The security assembly according to claim 1, wherein the rotating member is spring loaded.

15. A method of securing a lockbox, the method comprising:
a) providing a docking bracket that is mountable to a surface;
b) providing a lockbox having a first compartment and a second compartment, wherein said first compartment constitutes an interior volume of said lockbox separate from said second compartment, and said second compartment contains a latching assembly that is adapted to interact with a complementary engagement element of said docking bracket
c) positioning and placing said lockbox in a substantially normal orientation relative to said complementary engagement elements of said docking bracket such that a number of said complementary engagement elements insert into a number of holes in a portion of a bottom wall of said lockbox;
d) accessing said first compartment of said lockbox and turning a switch handle therein to actuate said latching assembly such that said latching assembly engages with said complementary engagement elements of said docking bracket.

16. The method according to claim 15, wherein said docking bracket is fastened to a mountable substrate.

17. The method according to claim 15, wherein said docking bracket is fastened to a mountable substrate in a motor vehicle.

18. The method according to claim 15, wherein said latching assembly involves rotating a carousel member having engagement rods, to extend said engagement rods, which insert into corresponding holes in said engagement elements.

19. The method according to claim 15, wherein said latching assembly in the second compartment of the lockbox includes a counter-motion mechanism that is designed to help with the turning of a rotating hub and movement of engagement rods.

20. The method according to claim 19, wherein said counter-motion mechanism is actuated with one or more springs in various configurations or combinations.
